(19) United States
(12) Patent Application Publication
(10) Pub. No.: US 2013/0017309 A1
(43) Pub. Date: Jan. 17, 2013

(54) FROSTING SYSTEMS AND RELATED METHODS AND DISPLAY UNITS

(71) Applicants: Christopher Puno, Branchburg, NJ (US); Rachel Avila, Springfield, PA (US); Margaret Cadore, Hackettstown, NJ (US); William Wang, East Hanover, NJ (US); Stephen Gunther, Great Meadows, NJ (US); Sharon McGuire, Long Valley, NJ (US)

(72) Inventors: Christopher Puno, Branchburg, NJ (US); Rachel Avila, Springfield, PA (US); Margaret Cadore, Hackettstown, NJ (US); William Wang, East Hanover, NJ (US); Stephen Gunther, Great Meadows, NJ (US); Sharon McGuire, Long Valley, NJ (US)

(21) Appl. No.: 13/549,947

(22) Filed: Jul. 16, 2012

Related U.S. Application Data
(60) Provisional application No. 61/507,848, filed on Jul. 14, 2011.
(60) Provisional application No. 61/576,906, filed on Dec. 16, 2011.

(51) Int. Cl. A23G 3/34; B65B 3/04; A23L 1/226

(52) U.S. Cl. 426/650; 426/659; 434/365; 53/474

(57) ABSTRACT

A frosting system is disclosed. The frosting system includes a base material in a container and at least one packet. The packet may contain one or more flavor additives and/or one or more color additives. A user adds one or more packets to a base material in a container and mixes the packet(s) with the base material to arrive at a final frosting. Related methods and display units are also disclosed.

### CROSS-REFERENCE TO RELATED APPLICATIONS

This application claims the benefit of U.S. Provisional Patent Application Ser. No. 61/507,848 filed Jul. 14, 2011, entitled “FROSTING WITH FLAVOR PACKS,” and U.S. Provisional Patent Application Ser. No. 61/576,906, filed Dec. 16, 2011, entitled “FROSTING SYSTEM,” both of which are hereby incorporated by reference in their entireties.

### BACKGROUND

Traditionally, many commercially available frostings are packaged, sold and purchased as unitary products. For example, one can purchase a package of a ready-to-spread (“RTS”) frosting or a whipped frosting in whatever flavor is in stock at the place of purchase. Such packages of frosting are typically ready to use upon purchase. Such packages occupy significant space on retailer shelves, and thus tend to limit the flavor offerings and consumer choices that a retailer can make available.

Other types of commercially available frostings are sold and purchased as mixes, where consumers add ingredients such as water to arrive at a final frosting. These offerings, often provided in boxes, similarly require retailers to stock only particular flavors because of limited shelf space.

Additives such as color and flavor additives are currently available to be added to a variety of foodstuffs, including frostings. Some such additives come in liquid or paste form, and can be difficult to disperse in frostings, requiring significant stirring time and effort greater than typical consumers would be expected to give. Liquid and paste-like additives also have unique packaging challenges. For examples, a pouch containing a liquid may need specialized packaging to avoid puncture and leakage. Also, in at least some instances, liquid and paste-like additives may have a shorter than desired shelf life.

Some additives may come in solid form such as a powder. Certain conventional powder additives, however, have chemical and/or physical traits (such as particle sizes) that are too large for efficient mixing and dispersion in a frosting. Such powders may agglomerate and cause undesired specking

Additionally, certain additives may not be compatible with other additives. For example, a chemical reaction between a color additive and a flavor additive may have a negative impact on color, flavor or both.

Additionally, because many commercially available frostings have been packaged, sold and purchased as unitary products for such a lengthy time period, changes to that concept may require explanation or instruction to consumers. For example, if a frosting system is sold that is multi-component (a base material plus one or more packets), then certain instructional, marketing and sales innovations may be desired to assist consumers with purchasing and using the frosting system. For example, consumers may need to be taught to purchase more than one component of a multi-component frosting system to arrive at a final frosting.

### BRIEF DESCRIPTION OF THE DRAWINGS

The features and inventive aspects will become apparent upon reading the following detailed description, claims, and drawings, of which the following is a brief description:

FIG. 1 depicts an exemplary frosting system.

FIG. 2 illustrates a use of the exemplary frosting system of FIG. 1.

FIG. 3 illustrates a use of the exemplary frosting system of FIG. 5.

FIGS. 4-7 illustrate potential color uniformity and specking issues addressed by exemplary frosting systems.

FIGS. 8-11 illustrate improved color uniformity in exemplary frostings.

FIG. 12 illustrates an exemplary manufacturing procedure that may be used to manufacture a base material for a frosting system.

FIG. 13 illustrates exemplary packaging for exemplary frosting systems.

FIG. 14 illustrates exemplary flavors for an exemplary frosting system.

FIG. 15 illustrates exemplary combinations of flavors for exemplary frosting systems.

FIG. 16 illustrates an exemplary marketing display for an exemplary frosting system.

FIG. 17 illustrates exemplary display units for displaying exemplary frosting systems on store shelves.

### DETAILED DESCRIPTION

Referring now to the drawings, illustrative embodiments are shown in detail. Although the drawings represent certain examples, the drawings are not necessarily to scale and certain features may be exaggerated to better illustrate and explain an innovative aspect of an example. Further, the examples described herein are not intended to be exhaustive or otherwise limiting to the precise form and configuration shown in the drawings and disclosed herein.

Without limiting the invention to only those embodiments expressly disclosed, and without disclaiming any embodiments, some embodiments comprise the preparation of a frosting using a base material received in a container and adding a flavor pack that may also contribute color to create a finalized frosting.

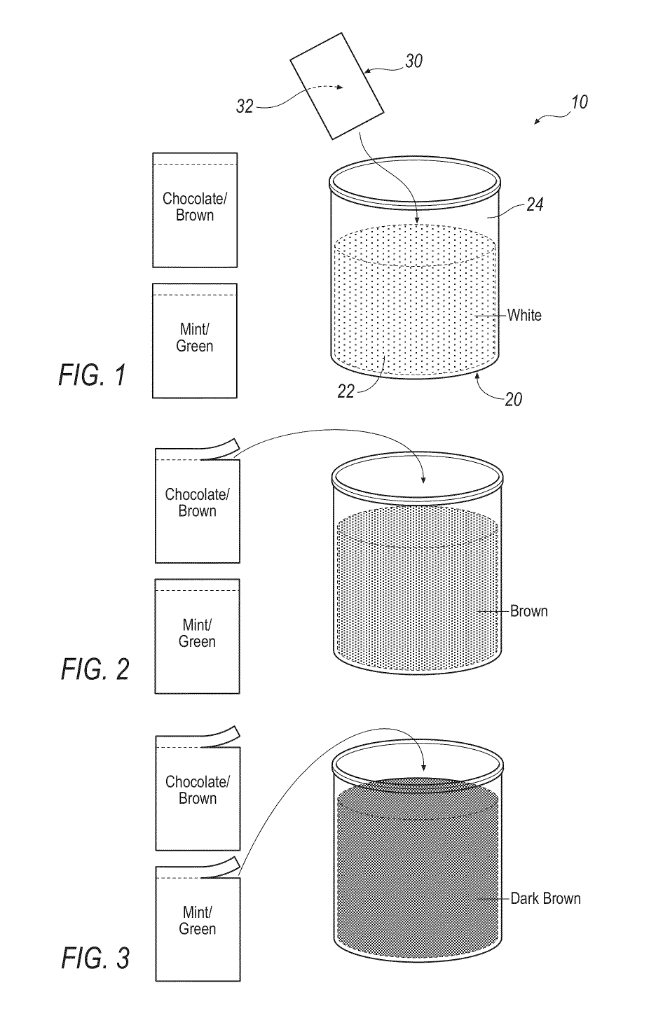

Referring to FIG. 1 (drawing not to scale), an exemplary frosting system 10 is shown. The frosting system 10 includes a container 20 for a base material 22. The frosting system further includes at least one packet 30 having contents 32, which include at least one of a flavor or color additive. The contents 32 of packet 30 are mixable with the base material 22 to arrive at a final frosting.

The container 20 may be formed from one or more of a number of materials, including, but not limited to, metal and plastic. The container 20 may be sized to accommodate volumes of base material desirable to consumers. In one example, the container 20 includes sufficient headspace 24 above the base material 22 so that the contents 32 of one or more packets 30 may be added to the base material 22 and stirred or otherwise mixed to arrive at a final frosting while within container 20. In such an example, the headspace 24 may comprise from about 22% to about 28% by volume of the container 20. For example, in a container 20 having capacity of 153 ml, the headspace in the container 20 may be about 43 ml, which is about 28% headspace. In one exemplary system, without limitation, the container 20 is sealable on all sides to enclose the base material and headspace after placement of the base material therein. Optionally, the container may be resealable and/or have a lid or covering (not shown) retaining and/or covering the contents of the container 20.

### Base Material

The base material 22 may be a frosting suitable for eating even in the absence of contents 32 of packets 30. In one exemplary base material 22, the frosting has a light color and a subtle flavor so it can be readily modified by the contents 32 of one or more packets 30. By way of non-limiting example, non-overpowering natural or artificial flavor additives such those imparting a marshmallow or vanilla flavor may be suitable for a base material 22. Additionally, one or more sweeteners such as sugar or corn syrup may be suitable for the base material 22. Similarly, non-overpowering colors such as titanium dioxide may be suitable for a base material 22.

Ingredients in a nonlimiting, exemplary base material 22 include sugar, which may be present in an amount from about 30% to about 60% by weight, corn starch, which may be present in an amount of from about 0.5% to about 5.0% by weight, water, which may be present in an amount of from about 10% to about 20% by weight, corn syrup, which may be present in an amount of from about 2% to about 10% by weight, flavor additives, which may be present in an amount of from about 0% to about 1% by weight, color additives, which may be present in an amount of from about 0% to about 1% by weight, shortening (including but not limited to non-emulsified shortening), which may be present in an amount of from about 15% to about 30% by weight, salt, which may be present in an amount of from about 0% to about 1% by weight, emulsifiers (including but not limited to monoglycerides and polysorbates), which may be present in an amount of from about 0.5% to about 2% by weight, and gums and starches, which may be present in an amount of from about 0.5% to about 15% by weight. It is contemplated that one or more of the exemplary ingredients may be eliminated, replaced, or substituted, and that one or more of the exemplary ingredients may be present in an amount outside of the ranges depicted herein. Optional natural and artificial ingredients may also be included in the base material 22, such as preservatives, surfactants, viscosity building ingredients, fat or sugar substitutes, mold inhibitors, buffers, food acids, antioxidants, vitamins, minerals, nutraceuticals and sequestering agents.

The base material 22 may have a density low enough to permit mixing of the contents 32 of one or more packets 30 such that a final frosting with a smooth mouthfeel (that is, not grainy in texture) can be arrived at in less than five minutes. A final frosting is one with a generally uniform texture and color. Un-matching color particles or agglomerated larger particles giving the frosting a grainy consistency, collectively called specking, are minimized in a final frosting.

In one exemplary frosting system, mixing or stirring of the contents 32 of the packets 30 into the base material 22 should take from about 90 seconds to about 180 seconds to arrive at a final frosting. It is contemplated that durations required for mixing or stirring may vary depending on the number of packets being used, and the technique and vigor of the mixer or stirrer. The density of the base material 22 may be as low as a whipped frosting for a low density RTS frosting, which may range from about 0.7 to about 1.1 g/cc.

The base material 22 may have a viscosity that permits mixing of the contents 32 of one or more packets 30 that similarly permits mixing or stirring to arrive at a final frosting in less than five minutes. In one exemplary base material 22, the viscosity may range between 30,000 cP and 75,000 cP. It is contemplated that the viscosity of base material 22 may be higher or lower than the exemplified range, and that viscosity agents can be added or removed to adjust the viscosity.

The base material 22 may have an emulsifying system that gives the base material 22 a hydrophilic-lipophilic balance (HLB) profile. An HLB profile is a numeric range from 0 to 20. The HLB of a particular emulsifier is determined by calculating the weight percentage of hydrophilic portion of that emulsifier and dividing by five (5). If an HLB is low, it has more lipophilic traits (including oil solubility) than hydrophilic traits (including water solubility), and if an HLB is high, it has more hydrophilic traits than lipophilic traits. Low HLB systems favor water-in-oil emulsions, and high HLB systems favor oil-in-water emulsions. By way of non-limiting example, soy lecithin is available with an HLB of 4.0 as a water-in-oil emulsifier.

A number of gums and starches may be included in an emulsifying system for the base material 22. Exemplary gums may include both natural and synthetic gums. Exemplary gums may include but are not limited to cellulose gum, modified gum acacia, guar gum, xantham gum, and locust bean gum. Exemplary starches may include both natural and synthetic starches. Exemplary starches may include but are not limited to cornstarch, modified food starch, arrowroot, potato starch and sago. It is contemplated that additional emulsifiers such as proteins may optionally be included with an emulsifying system for the base material 22.

### Packets

In some nonlimiting embodiments, packet 30 may be small in size and shape, and take up little shelf space relative to a container 20 of base material 22. Packets 30 may be formed of plastic, paper, cardboard, or any combination thereof. Packets 30 include contents 32, which include at least one of a flavor or a color additive. Thus, when a variety of packets 30 have different contents 32 from one another, a wide variety of flavor and color offerings can be provided without using much retail shelf space.

One or more flavor additives in contents 32 may impart a flavor to the base material 22 after the contents 32 are mixed in the base material 22. The imparted flavor may one sold by the manufacturer and retailer, or one created by a consumer by combining one or more packets 30. By way of non-limiting example, the imparted flavor may be bubble gum, caramel, cherry vanilla, chocolate almond, chocolate marshmallow, cinnamon roll, cotton candy, mint chocolate, mocha, orange crème, strawberry shortcake and white chocolate raspberry. These exemplary flavors are imparted flavors sold to consumers under the registered trademark “Duncan Hines”. Combinations of packets 30 can impart additional flavors. By way of non-limiting example, a consumer may choose to combine a bubble gum packet 30 and a cotton candy packet 30 in a common base material 22 to create a child-friendly flavor in a final frosting. Similarly, a consumer may choose to combine a caramel packet 30 with a mocha packet 30 in a common base material 22 to create a caramel mocha flavor in a final frosting. The consumer may select any of a number of combinations of packets 30.

Certain flavors are generally associated with a certain range of colors. For example, a number of shades of the color brown are “complementary” as used herein with the flavor chocolate. Contents 32 of packets 30 may also include color additives to impart a color to the base material 22 that is complementary to the imparted flavor. Thus, if a packet 30 includes contents 32 that impart a flavor such as bubble gum, caramel, cherry vanilla, chocolate almond, chocolate marshmallow, cinnamon roll, cotton candy, mint chocolate, mocha, orange crème, strawberry shortcake and white chocolate raspberry, the contents 32 of the same packet 30 may also impart a color complementary to the flavor.

The contents 32 of a packet 30 may be in solid form, such as a powder. The powder may dissolve and disperse in the base material 22 when mixed or stirred as described above. The average particle size of the powder should be sufficiently small, which increases the surface area to mass ratio for dissolution and dispersion. In one example, the average particle size of the powder is such that at least about 70% of the powder will pass through a 60 mesh screen. In another example, the average particle size is such that at least about 90% of the powder will pass through a 60 mesh screen. Typically the average particle diameter of particles in a packet 30 will be less than 250 microns.

Flavor additives in contents 32 may be powders. In one example, flavor additives comprise spray-dried flavor powders. Plated flavor powders may additionally or optionally be included in a packet 30. If plated flavor powders are included, the weight percentage of same should be less than approximately 55% by weight of the contents 32 of the packet 30 to minimize or prevent specking For flavors having darker complementary colors, contents 32 of packet 30 may comprise about 20% to about 60% by weight of flavor additives. For flavors having lighter complementary colors, contents 32 of packet 30 may comprise about 30% to about 85% by weight of flavor additives. It is contemplated that flavor additives may be in contents 32 of packet 30 in an amount outside of the exemplary ranges.

Color additives in contents 32 may be powders having an emulsifier system associated therewith. Such an emulsifier system may include, for example, soy lecithin and/or soy bean oil. To increase dispersion of the color powder in the base material 22, the emulsifier system associated with the color powder may have an HLB profile that is compatible with the HLB profile of the base material 22. Emulsifier HLB profiles are “compatible” as used herein if they are within three (3) integers of one another. The closer the HLB profile is between the color powder emulsifier system and the base material 22, the better and the more even the dispersing of the powder may be base material 22.

For flavors having darker complementary colors, contents 32 of packet 30 may comprise about 9% to about 50% by weight of color additives. For flavors having lighter complementary colors, contents 32 of packet 30 may comprise about 1% to about 8% by weight of color additives. It is contemplated that color additives may be in contents 32 of packet 30 in an amount outside of the exemplary ranges.

The contents 32 of packets 30 may also include optional ingredients, such as carriers. One exemplary carrier is maltodextrin. Other optional ingredients may be present.

The whipped process and formulation may be adjusted for frosting base characteristics to facilitate the addition of flavor packs, considering factors including, but not limited to, ease of stirring the flavor packet into the base, mouthfeel, and frosting texture. Nitrogen incorporation may be adjusted to improve the overall texture of the product as well as for deflation of the base during stirring. Moreover, ingredients such as starches and gums may be used to adjust the viscosity, and the amount of starches and gums in the frosting base may be increased compared to conventional whipped frostings. Exemplary starches include but are not limited to cornstarch and modified food starch. Exemplary gums include but are not limited to cellulose gum and modified gum acacia.

An exemplary stabilizer system includes a blend of gums and starches and absence of salt. A non-salt environment may be used to facilitate hydration of the gum blend. Salt (NaCl) is added later in the process (different mixing tank) to impart a flavor enhancement. In one exemplary approach the resulting base material is white to facilitate the addition of coloring as discussed below. Moreover, in one exemplary approach, the base material is intentionally of a very neutral taste to facilitate the receipt of flavoring. In any event the base material has the capability of being modified through the addition of a flavoring to result in a desired flavor. The base material is an oil/water emulsion. Once the base material has been initially it may be held for a time (e.g., approximately two days) for a crystalline network to set.

An exemplary frosting system is shown in FIG. 1. The exemplified frosting system is multi-component. One component is a base material 22 in a container 20. Another component is one or more packs 30 containing flavor and/or color 32 to be mixed with the base material 22. The contents of the packs 30 may include one or more powders. In the exemplified frosting system of FIG. 1, the frosting system uses two packs, a chocolate/brown pack and a mint/green pack.

As shown in FIG. 1, once the base material 22 has been finalized it can be stored in a container 22. In one nonlimiting example, to facilitate preparation of the finished frosting the base preferably has a free headspace 24 in its container of at least approximately 22% and generally on the order of approximately between 22% and 26%. In one exemplary approach the headspace 24 takes up approximately 43 ml while the frosting space is approximately 153 ml, resulting in the percentage of headspace of approximately 26%.

To create or make a finalized frosting from a frosting system, as shown in FIG. 2, at least one pack of flavoring (typically of a color other than the base material) is added to the base material already in the container, thereby adding flavor and possibly a color to the base material.

As shown in FIG. 3, in some approaches more than one pack may be added to the base material in an additive approach (e.g., both chocolate and mint to create mint chocolate). For example, the coloring of a frosting with a chocolate flavoring pouch added may be different from a frosting with a mint flavoring pouch. Moreover, when both flavoring pouches have been added to the base material not only is flavor affected, but the resulting color may be different than if only one or the other flavoring pouch had been added to the base material.

The contents of the pack may generally be in a powder format and dissolve in the base material when placed in contact. The powder is formulated to facilitate its dissolution in the base material. To this end, the average particle size of the flavor powder and the color powder, as well as the combination of both, should be sufficiently small, increasing the surface area to mass ratio. This increased ratio may aid in dissolving and dispersing the pack in the base material in exemplary frosting systems. In one nonlimiting example, the average particle size of powders added to the frosting is such that at least about 70% of a given powder batch will pass through a 60 mesh screen. In another example, the average particle size of powders added to the frosting is such that at least about 90% of a given powder batch will pass through a 60 mesh screen. Typically, the average particle size will be less than 250 microns.

One or more of the powders in the pack may have elevated levels of emulsifier such as soy lecithin or soy bean oil, which may enhance dispersion. The addition of soy lecithin to the color has multiple functions. Lakes inherently are self-agglomerating in their dry form as they are very electrostatic in nature and have a tendency to bind to one another. It is advantageous to limit the agglomeration of these particulates in order to reduce the amount of specking once it is dispersed throughout the frosting. By coating the individual particles of color with soy lecithin, the tendency to agglomerate are reduced. This is further limited by the addition of silicon dioxide, an ingredient added to prevent agglomeration and clumping. Secondly, soy lecithin aids in the dispersion of the oil soluble lake evenly throughout the oil phase of the frosting itself. Soy lecithin is a surfactant derived from soybeans. With a hydrophilic-lipophilic balance (HLB) of approximately 4.0, the soy lecithin provides additional oil solubility to the already soluble nature of the lake particles. To increase dispersion, for example, color powders may be selected to have a hydrophilic-lipophilic balance (HLB) profile compatible with the HLB profile of the base material. An emulsifying system can be made by using one or more emulsifiers to generate a particular HLB profile. For example, Canola Oil has an HLB profile of 7±1, Polysorbate 80 has an HLB profile of 15±1. If the two are combined in equal parts by weight, a resultant emulsifying system will have an HLB of 11.5±1.

One or more of the powders in the pack may be spray dried. Plated powders such as plated flavor powders may be minimized or eliminated to minimize specking One exemplary process to make the flavoring is a dry mixing operation using devices such as a ribbon blender or a paddle mixer. In general the colors are oil soluble lakes while the flavors are primarily water dispersible. Both the color(s) and flavor(s) may be in powder a format, together in a common pack or in separate packs.

In some nonlimiting embodiments, one or more packs are added to the frosting base material, which may be at room temperature, and mixed by the end consumer using either a hand implement (e.g., a metal dinner knife, whisk or a spatula or spoon) or a mixer. When mixing a flavoring pack into the base material the oil soluble color and water dispersible flavor interact with the separate phases of the base, which is an oil/water emulsion as noted above. The flavor packet is a combination of three components, flavors and dextrose, both of which are water soluble and the colors that are oil soluble. Dextrose is added to each formulation in order to maintain the fill weight across the different varieties consistent. The choice to use materials with different solubilities was intentional. Since the frosting base is also a two part system, water in oil emulsion, the flavoring component would be dissolved in the water phase while the color would be dispersed evenly throughout the oil phase. Having similar solubilities in the packet would lead to competition in either available water or oil in the frosting, compounding the specking issue. Water soluble colors were evaluated early in during development but did not perform well as they still exhibited specking but also the colors faded very rapidly after being mixed with the frosting.

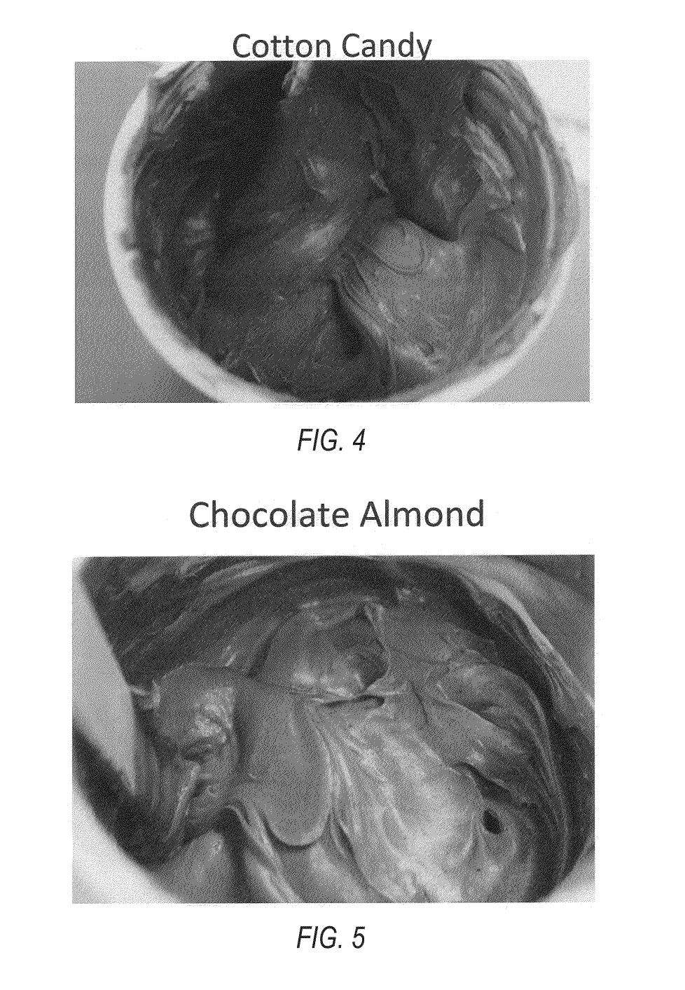

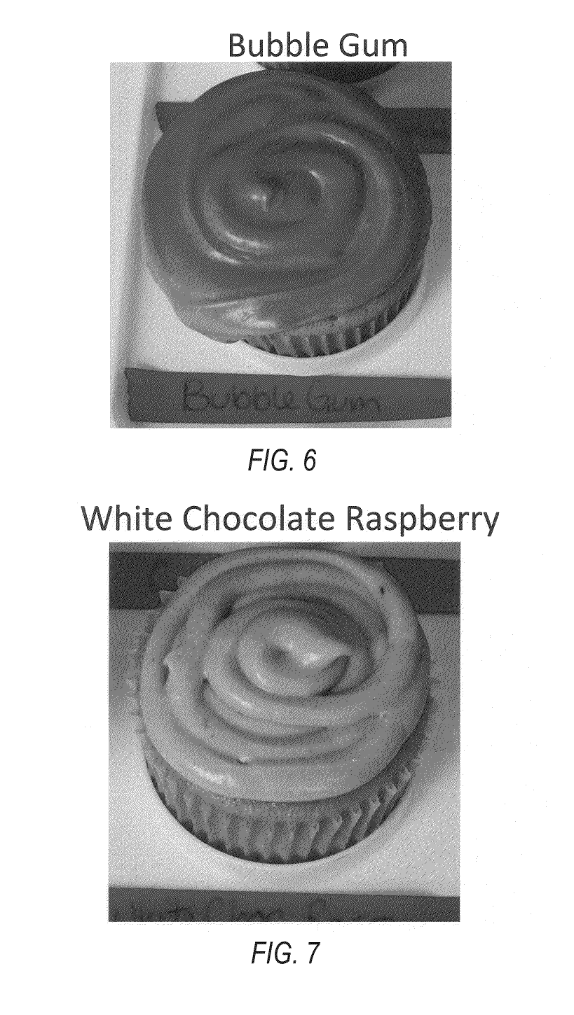

A desired finalized frosting will have a generally uniform texture and color such that the visibility of color particles is minimized. As one example, there should be minimized specking, which is the localized dissolving of a particle of powder thereby causing dark “specks”. FIGS. 4-7 exemplify finalized frostings with non-uniform textures and/or colors. For example, in FIG. 4, bumps are visible in the texture where flavor and/or color particles may have agglomerated and did not get properly dissolved or dispersed. In FIG. 5, blue specks are visible, detracting from the otherwise uniform light brown color. In FIG. 6, bumps are visible in the texture. In FIG. 7, dark specks are visible, detracting from the otherwise uniform pink frosting.

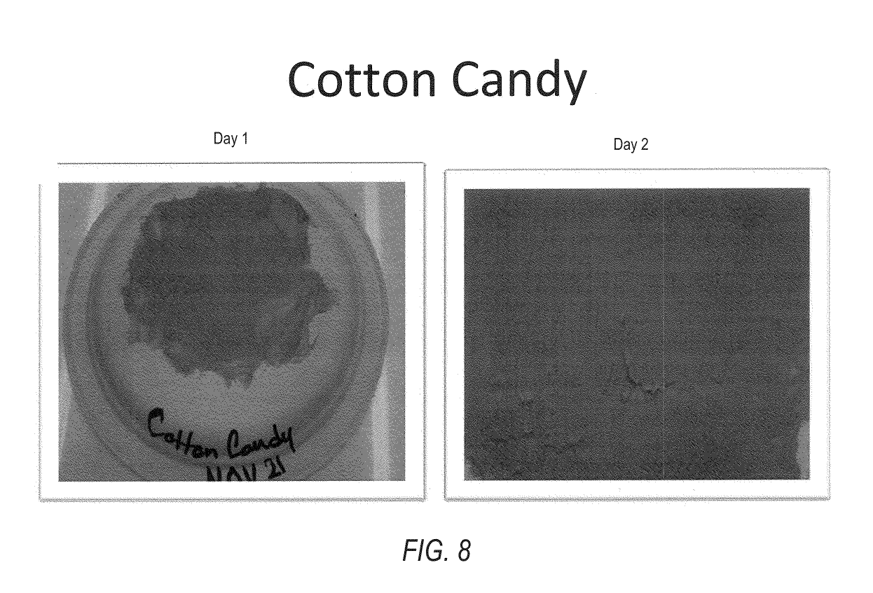

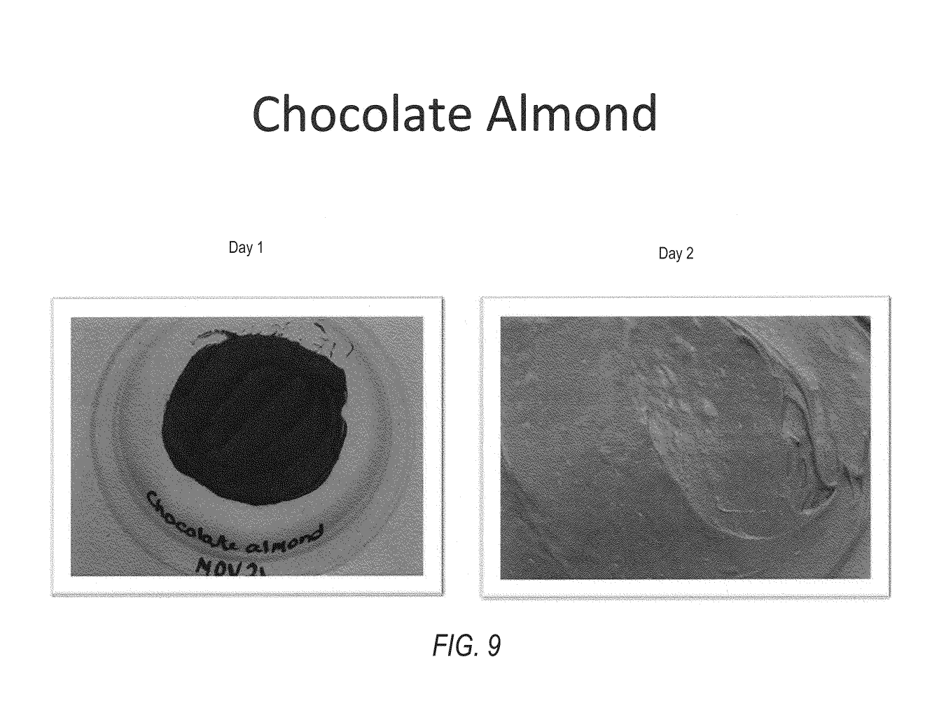

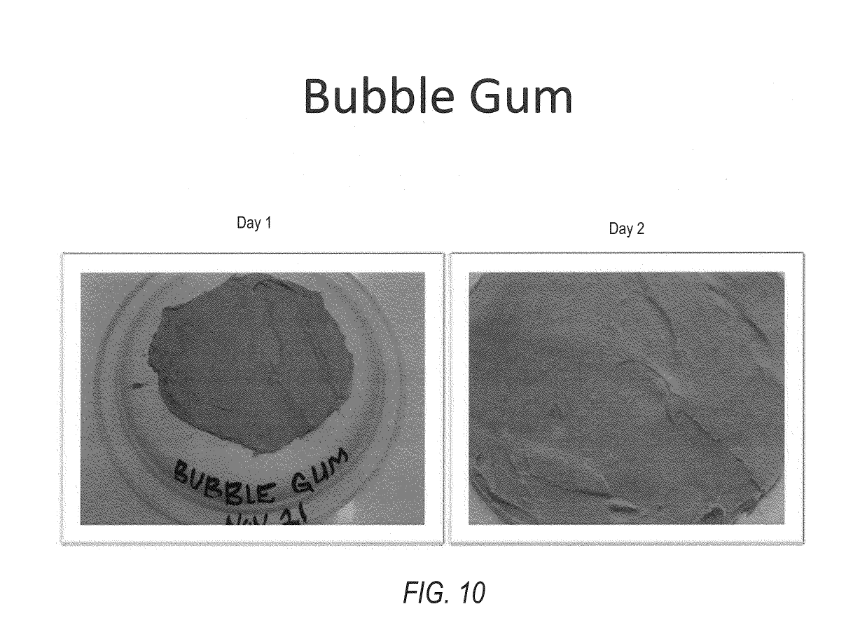

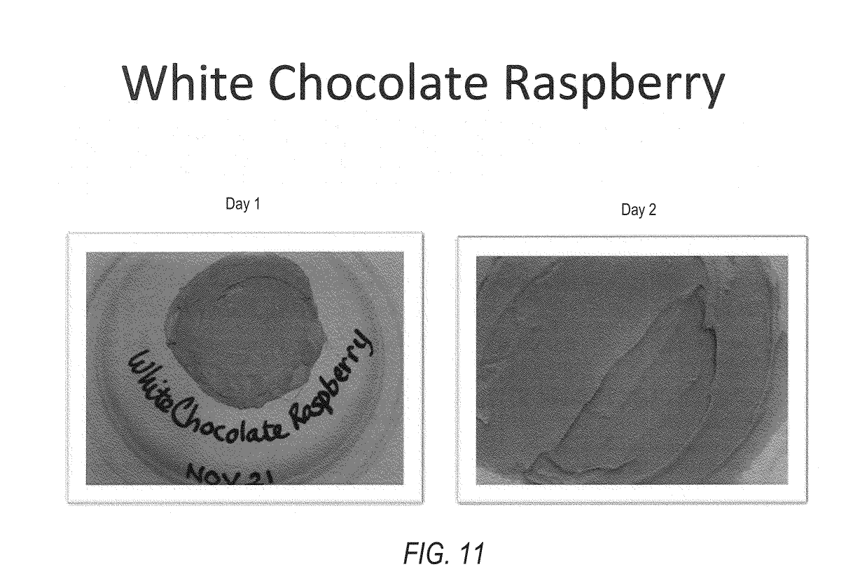

By contrast, FIGS. 8-11 have a generally uniform texture and color without undesired specking The frosting systems of FIGS. 8-11 was optimized by including spray dried powder flavor and color having an average particle sizes of less than 250 microns, by minimizing plated flavor powders, and by selecting colors having an emulsifying system compatible with the HLB profile of the frosting base material.

Any powder distribution in the base material should be generally uniform and the resulting frosting may have a smooth mouthfeel (i.e., not grainy in texture). The time to mix the pack into the frosting base material should be minimized. In some exemplary frosting systems, mixing time of no longer than 5 minutes is desirable. In other exemplary formulations, mixing time may range from about 90 seconds to about 180 seconds.

Depending on the nature of the flavor pack being used it may be desirable to increase the viscosity and stability of the base material before placing it in its container so that the resulting frosting is not too thin after the flavor pack has been mixed in. The viscosity and stability of the base may be increased. Exemplary approaches include increasing the percentage of gum in the aqueous phase as well as modifications to both the holding temperature and time post processing. An exemplary viscosity range using a Brookfield Spindle #5 is 10,000 -12,000 cP, torque range 30-80%. In some nonlimiting embodiments, the sugar level, fat or fat type, and/or level of modification of the fat (e.g., hydrogenation) may be adjusted to control the viscosity of the base material.

### Manufacturing Methods

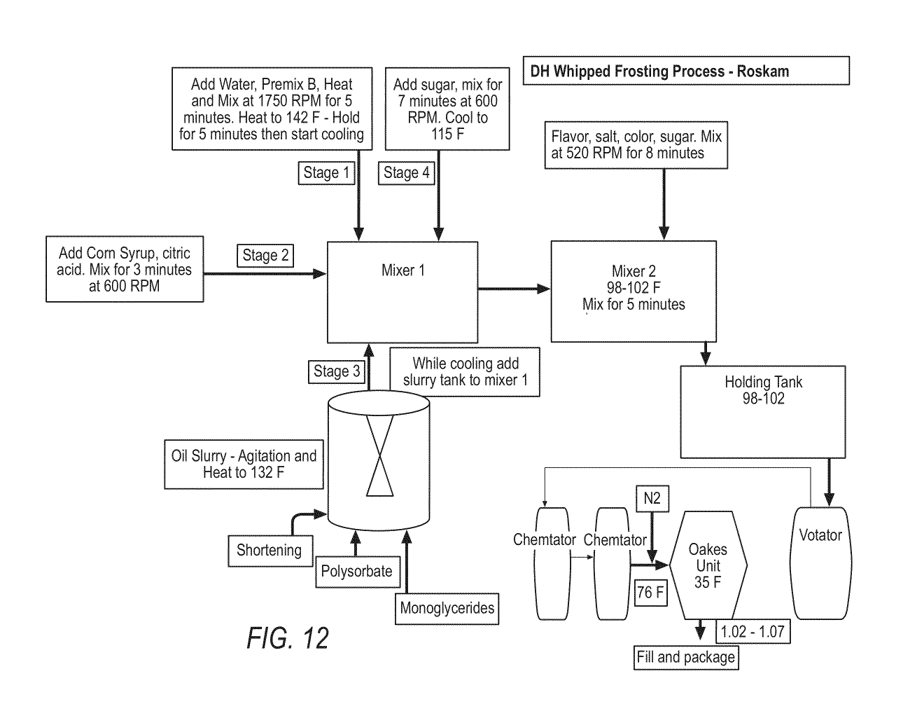

FIG. 12 describes an exemplary manufacturing method that may be used in connection with manufacturing exemplary base materials. In stage 1, water and an exemplary premix of fine granulation sugar, a stabilizer blend of gums and starches, potassium sorbate granules and sodium pyrophosphate is added to a tank, mixer 1. The premix may comprise about 76% by weight of fine granulation sugar, about 20% by weight of stabilizer blend of gums and starches, about 2% by weight of potassium sorbate granules, and about 1% by weight of sodium acid pyrophosphate. The mixture is heated to about 142° F. and mixed at high RPM, exemplified at 1750 RPM. The mixture is then held in mixer 1 for about five minutes to cool. In stage 2, corn syrup and citric acid are added to mixer 1 and mixed for about 3 minutes at low revolutions per minute (RPM), exemplified at 600 RPM. In stage 3, an oil slurry that has been agitated and heated to about 132° F. is added to mixer 1 while the contents of mixer 1 are cooling. The oil slurry may contain about 97% by weight of shortening (non-emulsified), about 2% by weight of distilled monoglycerides, and about 1% by weight of polysorbate 60. In stage 4, depending on the volume capacity of mixer 1, some or all of ground powdered sugar is added and stirred at low RPM, exemplified at 600 RPM and heated cooled to about 115° F. The ground powdered sugar mix may optionally contain about 3% by weight of corn starch and 97% by weight of powdered sugar. No salt is added in mixer 1, which without being bound by theory is thought to aid hydration.

Materials are transferred to mixer 2. If necessary the remainder of the powdered sugar is added. The remainder of ingredients are added in mixer 2, including flavors, salt, color, and more sugar. In one example, materials ultimately added to mixer 2 include a mixture comprising about 49% by weight of ground powdered sugar, about 21% by weight of a whipped frosting oil slurry, about 15% by weight of water, about 8% by weight of corn syrup, about 6% by weight of gum premix, and less than about 1% by weight of each of salt, artificial marshmallow flavor, titanium dioxide, and citric acid. The material is mixed at low RPM, exemplified at 520 RPM. The contents of mixer 2 are heated to about 98° F. to 102° F. The materials are then transferred to a holding tank heated to about 98° F. to 102° F., then to a Votator, chemtators, nitrogen is added, transfer is made to an Oakes unit at about 98° F., and when the density is from about 1.02 to 1.07 g/cm3, the base is ready for packaging.

Packs to be used with such a base material in a frosting system may be made from selecting a combination of color powder and flavor powder and optionally a carrier, especially where the powders have an average particle size of less than about 250 microns and the color powder has an HLB profile compatible with the base material due it the emulsifying system in the color. For darker colors, packs for use in a frosting system may have about 9% to about 50% by weight of color powder, about 20% to about 60% by weight of flavor powder, with remainder in carrier and/or other additives. For lighter colors, packs for use in a frosting system may have about 1% to about 8% by weight of color powder and about 30% to about 85% by weight of flavor powder, with remainder including carrier and/or other additives.

### Display Unit and Related Materials

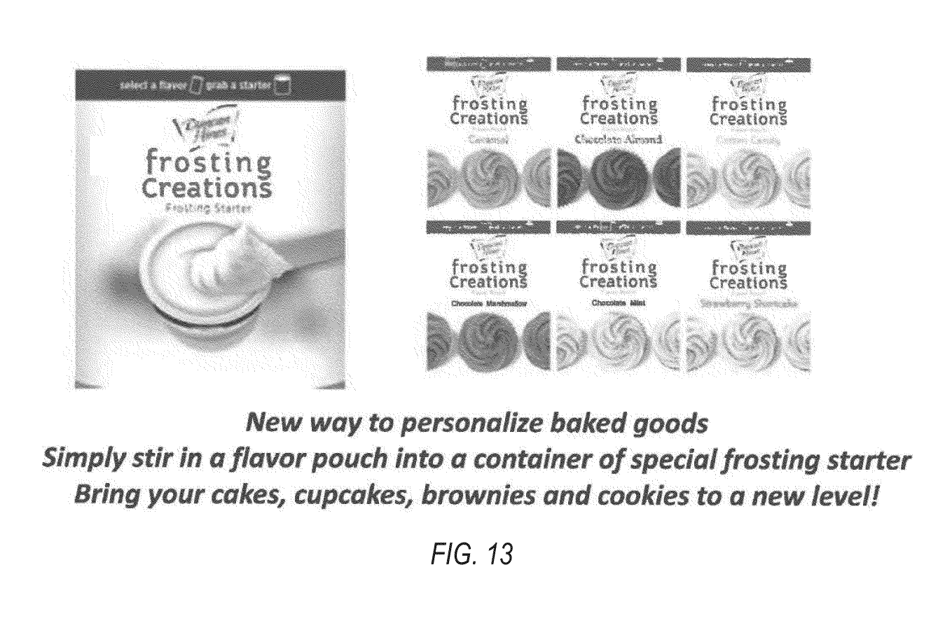

FIGS. 13-17 describe exemplary instructional, marketing and sales materials, as well as exemplary display units. FIG. 13 illustrates a frosting system showing a container of a base material together with six packets. One or more of the packets that impart flavor and/or color to the base material may be used in conjunction with the base material.

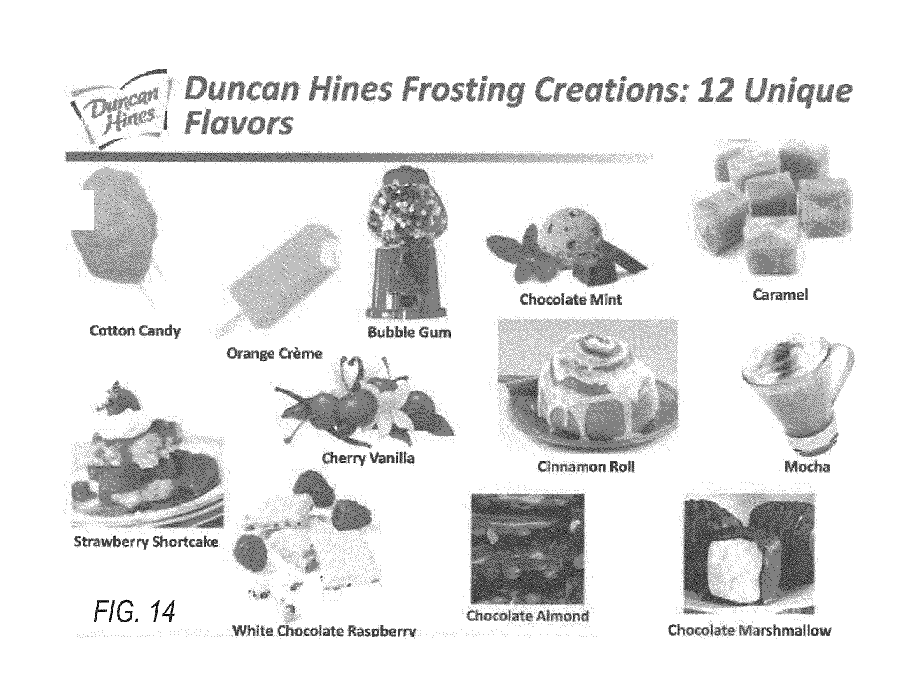

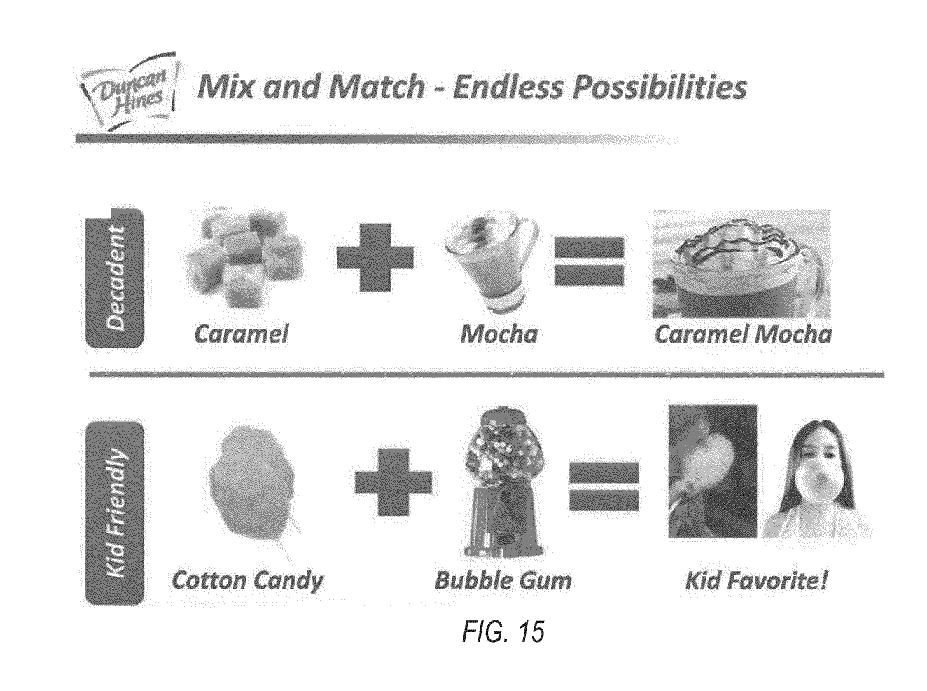

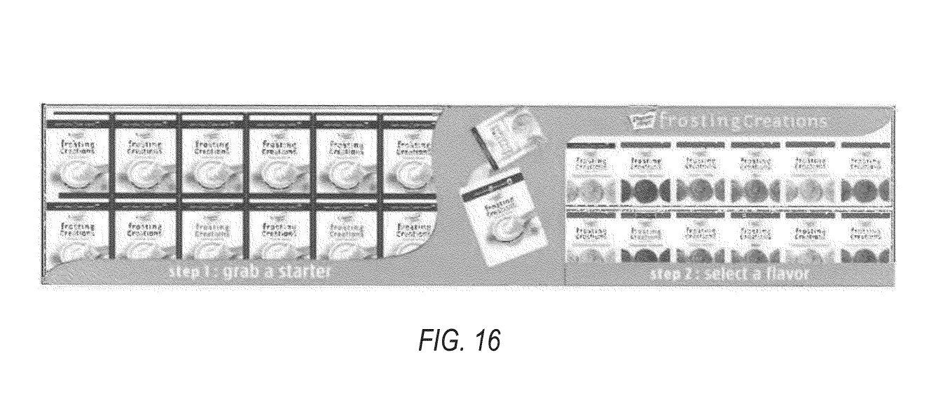

FIG. 14 identifies several flavors that can be imparted into a base material with the addition of a pack and a few minutes of stirring or mixing. FIG. 16 describes an advantage of the frosting systems described herein. Consumers can mix and match flavor packs to create their own flavors and colors with a base. FIG. 15 describes an exemplary instructional or marketing display unit to inform consumers how to use a multi-component frosting system. In the example of FIG. 16, a step 1 states “grab a starter” referring to a base material, and step 2 states “select a flavor” referring to the variety of flavor packs available in the display unit. Symbols such as artwork or photos on the display unit depict powder from a flavor pack being added to a base material.

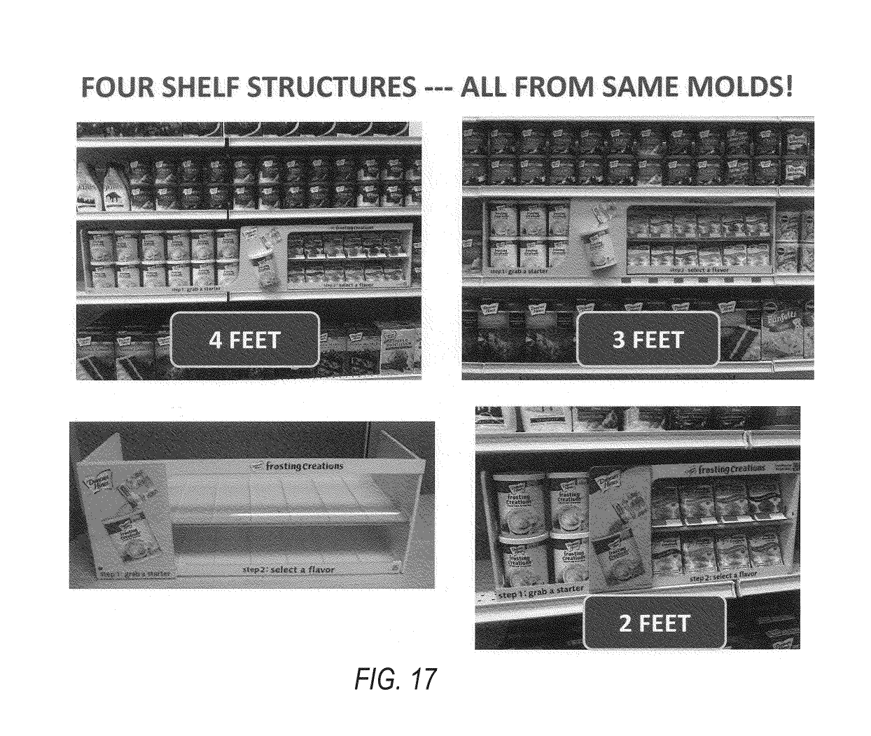

Similarly, FIG. 17 shows multiple exemplary display units for displaying the disclosed frosting system on a store shelf. In each exemplified display unit, there is an area for multiple containers of base material and an area for packs comprising powder adapted to impart at least a flavor or a color to the base material In the exemplified display units, there are words and graphics to explain the multi-component frosting system. In step 1, consumers are instructed to “grab a starter” and in step 2, consumers are instructed to “select a flavor”. Instructional graphics, drawings or photos are included. It is contemplated that any number of modifications in words or drawings could be made, including instructions to “make your own flavor” and the like.

### EXAMPLES

The following non-limiting example of a base material was prepared, to be used in a frosting system with one or more packs containing flavor and/or color.

### Example 1

| Ingredient | Lbs added | Weight percent |
|---|---|---|
| Sugar, Fine Granulation | 52.62 | 52.62 |
| Corn Starch | 1.48 | 1.48 |
| Water | 14.6 | 14.6 |
| Corn Syrup - 42DE | 7.55 | 7.55 |
| Artificial Marshmallow Flavor | 0.31 | 0.31 |
| Titanium Dioxide, water dispersible | 0.30 | 0.30 |
| Polysorbate 60 | 0.25 | 0.25 |
| Distilled Monoglycerides | 0.42 | 0.42 |
| Shortening Group 100 non emulsified | 20.5 | 20.5 |
| (Shortening) | | |
| Potassium Sorbate Granules-USP | 0.13 | 0.13 |
| Salt | 0.37 | 0.37 |
| Stabilizer Gum & Starch Blend | 1.30 | 1.30 |
| Sodium Acid Pyrophosphate | 0.06 | 0.06 |
| Citric Acid, anhydrous, fine granular | 0.02 | 0.02 |

The following non-limiting examples of powder packs with flavor, color and carrier were prepared for use in a frosting system by mixing the packs with a base material. With a few exceptions noted below, in each example, the flavors were provided by FCI Flavors based in Illinois, the colors were provided Chr. Hansen of Denmark, and the carrier/dextrose is provided by Tate & Lyle of Illinois. In Example 4, the flavor was supplied by McCormick of Maryland and in Example 6, the flavor was supplied by Synergy of Ireland. In Example 10, Carlyle Cocoa of Delaware provided cocoa powder and David Michael Flavors of Pennsylvania provided flavor. In Example 11, David Michael Flavors provided flavor. In Example 12, McCormick provided flavor. In Example 13, David Michael Flavors provided marshmallow flavor and Carlyle Cocoa provided chocolate flavor.

### Example 2

| Ingredient | Lbs added | Weight percent |
|---|---|---|
| Strawberry Shortcake Flavor | 180.5 | 60.2 |
| Red Lake #40 Blend | 9.63 | 3.21 |
| Carrier, StaleyDex 333 (Dextrose) | 109 | 36.6 |

### Example 3

| Ingredient | Lbs added | Weight percent |
|---|---|---|
| BubbleGum Flavor | 170 | 56.7 |
| Red Lake #40 Blend | 21.0 | 7.00 |
| Carrier, StaleyDex 333 (Dextrose) | 108 | 36.3 |

### Example 4

| Ingredient | Lbs added | Weight percent |
|---|---|---|
| Mint Chocolate Flavor | 255 | 85.0 |
| Green Lake Blend | 22.8 | 7.61 |
| Carrier, StaleyDex 333 (Dextrose) | 22.2 | 7.39 |

### Example 5

| Ingredient | Lbs added | Weight percent |
|---|---|---|
| Cotton Candy Flavor | 170 | 56.7 |
| Blue Lake Blend | 15.0 | 7 |
| Carrier, StaleyDex 333 (Dextrose) | 115 | 38.4 |

### Example 6

| Ingredient | Lbs added | Weight percent |
|---|---|---|
| Orange Cream Flavor | 90.0 | 30.0 |
| Orange Lake Blend | 21.0 | 7.00 |
| Carrier, StaleyDex 333 (Dextrose) | 189 | 63.0 |

### Example 7

| Ingredient | Lbs added | Weight percent |
|---|---|---|
| Cherry Vanilla Flavor | 115 | 38.4 |
| Cherry Flavor | 3.00 | 1.00 |
| Red Lake Blend | 27.1 | 9.03 |
| Carrier, StaleyDex 333 (Dextrose) | 155 | 51.6 |

### Example 8

| Ingredient | Lbs added | Weight percent |
|---|---|---|
| White Chocolate Raspberry Flavor | 192 | 64.0 |
| Purple Lake Blend | 21.0 | 7.00 |
| Carrier, StaleyDex 333 (Dextrose) | 87.0 | 29.0 |

### Example 9

| Ingredient | Lbs added | Weight percent |
|---|---|---|
| Cinnamon roll flavor | 172 | 57.6 |
| Tan Lake Blend | 27.0 | 9.00 |
| Carrier, StaleyDex 333 (Dextrose) | 100.2 | 33.4 |

### Example 10

| Ingredient | Lbs added | Weight percent |
|---|---|---|
| Cocoa powder | 58.1 | 19.4 |
| N&A almond flavor | 81.7 | 27.2 |
| Brown Lake Blend | 140 | 46.8 |
| Carrier, StaleyDex 333 (Dextrose) | 19.9 | 6.63 |

### Example 11

| Ingredient | Lbs added | Weight percent |
|---|---|---|
| Caramel flavor | 105 | 35.0 |
| Tan Lake Blend | 68.1 | 22.7 |
| Carrier, StaleyDex 333 (Dextrose) | 127 | 42.3 |

### Example 12

| Ingredient | Lbs added | Weight percent |
|---|---|---|
| Mocha flavor | 79.6 | 26.5 |
| Brown Lake Blend | 69.0 | 23.0 |
| Carrier, StaleyDex 333 (Dextrose) | 151 | 50.5 |

### Example 13

| Ingredient | Lbs added | Weight percent |
|---|---|---|
| Chocolate flavor | 58.1 | 19.4 |
| Marshmallow flavor | 63.5 | 21.2 |
| Brown Lakes Blend | 100.8 | 33.6 |
| Carrier, StaleyDex 333 (Dextrose) | 77.7 | 25.9 |

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. Examples of some embodiments of the invention are provided without limiting the invention to only those embodiments described herein and without disclaiming any embodiments or subject matter. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A frosting system, comprising:
a sealable container including a base material, and
at least one packet having contents of at least one of a flavor or a color additive, wherein said packet contents are mixable with the base material to arrive at a final frosting.

2. The frosting system of claim 1, wherein the container includes sufficient headspace to pour contents of one or more packets in the container and mix the packet with the base material in the container.

3. The frosting system of claim 1, wherein the container includes at least about 22% headspace.

4. The frosting system of claim 1, wherein the packet contents include at least one flavor additive and at least one color additive.

5. The frosting system of claim 1, wherein the packet contents are in the form of a powder.

6. The frosting system of claim 1, wherein the packet contents impart a flavor to the base material selected from the group consisting of bubble gum, caramel, cherry vanilla, chocolate almond, chocolate marshmallow, cinnamon roll, cotton candy, mint chocolate, mocha, orange crème, strawberry shortcake, and white chocolate raspberry.

7. The frosting system of claim 1, wherein the packet contents impart a color to the base material complementary to a flavor selected from the group consisting of bubble gum, caramel, cherry vanilla, chocolate almond, chocolate marshmallow, cinnamon roll, cotton candy, mint chocolate, mocha, orange crème, strawberry shortcake, and white chocolate raspberry.

8. The frosting system of claim 1, wherein the base material has a hydrophilic-lipophilic balance profile and wherein a color additive includes an emulsifier system compatible with the hydrophilic-lipophilic balance of the base material.

9. A display unit for displaying a frosting system, comprising:
a frame;
an area within the frame for displaying containers including base material;
a different area within the frame for displaying packets including contents having at least one of a flavor or a color additive;
an area on the frame for marketing or instructional information regarding the frosting system.

10. The display unit of claim 9, wherein at least a portion of a packet and at least a portion of a container are mounted in or on the area for marketing and instructional information.

11. The display unit of claim 10, wherein the area on the frame for marketing or instructional information includes at least a portion of a packet being tipped toward at least a portion of a container.

12. The display unit of claim 9, the area on the frame for marketing or instructional information includes a graphic depiction of a packet being tipped toward a graphic depiction of a container.

13. A method of manufacturing a frosting system, comprising:
manufacturing a base material having a hydrophilic-lipophilic balance profile;
packaging the base material in a container; and
packaging ingredients into a plurality of packets, wherein each packet contains
a color additive in powder form, the color additive having an emulsifier system compatible with the hydrophilic-lipophilic balance profile of the base material; and
a flavor additive in powder form.

14. The method of claim 13 wherein packaging the base material in the container comprises allowing sufficient headspace for eventual pouring of packet contents into the container with the base material and mixing.

15. The method of claim 13 wherein packaging ingredients into a plurality of packets includes adding powdered flavor and color into a packet comprising at least one of paper or plastic.

16. A frosting system manufactured by the method of claim 13.

17. A packet comprising powdered contents, including:
a flavor additive in powder form; and
a color additive in powder form, the color additive having an emulsifier system compatible with a hydrophilic-lipophilic balance profile of a frosting.

18. The packet of claim 17, wherein the packet contents are capable of imparting a flavor to a frosting, the flavor being selected from the group consisting of bubble gum, caramel, cherry vanilla, chocolate almond, chocolate marshmallow, cinnamon roll, cotton candy, mint chocolate, mocha, orange crème, strawberry shortcake, and white chocolate raspberry.

19. The packet of claim 17, wherein the packet contents are capable of imparting a color to a frosting, the color being complementary to flavor selected from the group consisting of bubble gum, caramel, cherry vanilla, chocolate almond, chocolate marshmallow, cinnamon roll, cotton candy, mint chocolate, mocha, orange crème, strawberry shortcake, and white chocolate raspberry.

20. The packet of claim 16 wherein the emulsifier system comprises soy lecithin.
